(19) United States
(12) Patent Application Publication
(10) Pub. No.: US 2025/0267232 A1
(43) Pub. Date: Aug. 21, 2025

(54) INTERACTIVE SYSTEM WITH TWO-WAY TRANSFORMING FUNCTION BETWEEN ENVIRONMENTAL PARAMETER DATA AND COLOR SPACE IMAGE

(71) Applicant: Chung Yuan Christian University, Chung Li (TW)

(72) Inventors: Yu-Chieh CHU, Chung Li (TW); Shih-Lun CHEN, Chung Li (TW); Tsung-Yi CHEN, Chung Li (TW); Ya-Yun HUANG, Chung Li (TW)

(21) Appl. No.: 18/760,280

(22) Filed: Jul. 1, 2024

(30) Foreign Application Priority Data
Feb. 20, 2024 (TW) 113105978

(51) Int. Cl. H04N 1/60; G06T 7/11; G06V 10/25; G06V 20/52; G06V 20/70

(52) U.S. Cl. CPC H04N 1/6008; G06T 7/11; G06V 10/25; G06V 20/52; G06V 20/70

(57) ABSTRACT

An interactive system with two-way transforming function between environmental parameter data and color-space image including an environmental data collecting device and a computing device is provided. The environmental data collecting device is provided for collecting a coordinate-bound type environment data set. The computing device is installed with a color space graphical application to build up a color label transforming regulation. After executing the color space graphical application, the computing device transforms the coordinate-bound type environment data set to a color space image composed of a plurality of colored blocks with respect to a plurality of value ranges of a plurality of grid space coordinates according to the color label transforming regulation. When a person observes the color space image and selects a region of interest from the color space image, the computing device further executes the color space graphical application to generate and display environmental parameter reconstruction data of the grid space coordinates within the region of interest.

### CROSS-REFERENCE TO RELATED APPLICATION

This application claims the priority benefit of Taiwan Application Serial No. 113105978, filed on Feb. 20, 2024. The entirety of the above-mentioned patent application is hereby incorporated by reference herein and made a part of specification.

### BACKGROUND OF THE INVENTION

### Field of the Invention

The present invention is related to an interactive system for showing environmental parameter data in color space, and more particularly is related to an interactive system with two-way transforming function between environmental parameter data and color space image.

### Description of the Related Art

Due to the influences of natural factors such as climate change, and human factors such as industrial pollution and land development, the human living environment has undergone more drastic changes. In order to handle these changes more accurately, it is often necessary to conduct long-term monitoring of indoor or outdoor spaces where humans live, so as to take appropriate countermeasures to adapt to these changes.

Taking large-scale outdoor climate and meteorological monitoring as an example, it is often necessary to install appropriate detection or monitoring equipment on some mobile carriers (such as meteorological satellites, drones, walrus monitoring ships, weather balloons or walrus monitoring floats) or fixed observation bases (such as weather stations or observation stations) for long-term monitoring such that climate changes can be accurately predicted and thus preventive measures can be taken in advance. However, in the existing technology, it is often necessary to store a large amount of monitoring data and use big data processing technology to record and analyze the environmental parameter data obtained by monitoring for a long time.

In addition, in order to allow experts to interpret the distribution of various environmental parameters in a large space, the environmental parameter data obtained by monitoring are often bound to spatial coordinates, which needs to occupy a large amount of storage space of data storage devices (such as web data servers). Even so, it is still not easy for humans to intuitively interpret the distribution of various environmental parameters from the environmental parameter data bound to spatial coordinates.

In order to make the distribution of environmental parameter data easier for humans to interpret intuitively, the environmental parameter data is often combined with a spatial map and converted into color space images of various environmental parameter data regions, such as temperature distribution map, rainfall distribution map, wind field intensity distribution map, or PM2.5 index distribution map. However, in this way, not only a huge storage space for storing the above-mentioned enormous data, but also an additional storage space for storing the color space images of various environmental parameter data regions is required.

In addition, when analyzing some regions in the space, it is also necessary to manually input the filtering region (such as the region of interest, ROI) conditions, and then identify the environmental parameter data matches the filtering region conditions in the huge environmental parameter (original) data (Raw Data) according to the filtering criteria. As a result, it will take more manual and software computing time to retrieve the environmental parameter data in the region of interest.

### BRIEF SUMMARY OF THE INVENTION

In view of the prior art, which has the problem that it is required to occupy a bigger storage space of the data storage device (such as a web data server) for storing the environmental parameter (original) data and color space images of environmental parameter data regions and also the problem that it is unable to retrieve environmental parameter data in the region of interest rapidly, it is a main object of the present invention to provide an interactive system with two-way transforming function between environmental parameter data and color space image, which uses a new type of data structure to store the environmental parameter data bounded to space coordinates, such that the objects of showing the color space image rapidly and accessing environmental parameter data in the region of interest rapidly in responsive to the interactive operation of the experts can be expected so as to resolve the aforementioned problems at the same time.

In order to solve the problems of the prior art, some embodiments of the present invention provide an interactive system with two-way transforming function between environmental parameter data and color space image (hereinafter referred to as “interactive system”), which comprises an environmental data collecting device and a computing device.

The environmental data collecting device is for collecting a coordinate-bound type environment data set of a monitored space, wherein the coordinate-bound type environment data set comprises a plurality of environmental parameter original data corresponding to a plurality of grid space coordinates in a space coordinate system of the monitored space. The computing device communicates with the environmental data collecting device for receiving the coordinate-bound type environment data set, is installed with a color space graphical application, and after executing the color space graphical application, the computer device generates a color space transforming module, a human machine interaction module, and a region of interest data reconstruction module.

The color space transforming module builds up a color label transforming regulation for the plurality of the environmental parameter original data, wherein the color label transforming regulation comprises a plurality of value ranges and a plurality of corresponding converted color labels so as to transform the coordinate-bound type environment data set to a color space graphical data by using the color label transforming regulation. The color space graphical data comprises a color space image corresponding to the monitored space, and the color space image is composed of a plurality of colored block shown by the plurality of the converted color labels corresponding to the plurality of the grid space coordinates.

The human machine interaction module is for showing the color space graphical data for an operator to watch and select a region of interest in the color space image of the color space graphical data. The region of interest data reconstruction module retrieves the converted color labels corresponding to part of the plurality of the grid space coordinates in the region of interest, and executes a regeneration transforming calculation according to the color label transforming regulation to generate a plurality of environmental parameter reconstruction data corresponding to the part of the plurality of the grid space coordinates in the region of interest shown on the human machine interaction module.

In one preferred embodiment of the present invention, the color space transforming module further comprises a layering unit, a regulation storing unit, a planar color space transforming unit, and a sequencing unit. The layering unit divides the monitored space into a plurality of planar spaces arranged according to a stacking order, wherein each of the plurality of the planar spaces comprises part of the plurality of the grid space coordinates. The regulation storing unit corresponds to the environmental parameter original data for storing the built-up color label transforming regulation.

The planar color space transforming unit is for transforming the environmental parameter original data corresponding to the grid space coordinates of each of the more than two of the planar spaces into a planar color space graphical data, so as to generate a plurality of the planar color space graphical data. The sequencing unit is for arranging the plurality of the planar color space graphical data according to the stacking order so as to compose the quasi-3D color space graphical data.

In one preferred embodiment of the present invention, the color space transforming module further comprises an obstacle region labelling unit, wherein the obstacle region labelling unit is for labelling a portion of a monitored region not belonging to the monitored space as at least one obstacle region, and using an obstacle specified color label other than the plurality of the converted color labels to label the at least one obstacle region.

In one preferred embodiment of the present invention, the interactive system further comprising a data transmission module, wherein the data transmission module is for uploading the color space graphic data to the environmental data collecting device to replace coordinate-bound type environment data set and being stored in the environmental data collecting device.

In one preferred embodiment of the present invention, the region of interest data reconstruction module comprises a range representative value computing unit, and the range representative value computing unit executes the regeneration transforming calculation to calculate a range representative value of each of the plurality of value range, so as to build up a value reconstruction table by using the range representative values corresponding to the plurality of converted color labels. Preferably, the range representative value can be accessed by calculating a middle value of each of the plurality of the value ranges, or by calculating an average value of the plurality of the environmental parameter original data of each of the plurality of the value ranges.

In one preferred embodiment of the present invention, the color space transforming module uses a RGB color code table, a CMYK color code table or a HEX color code table to define the plurality of the converted color labels. The region of interest data reconstruction module may further comprise an environmental parameter average value computing unit, and when using the RGB color code table to define the plurality of the converted color labels, the environmental parameter average value computing unit applies average calculation to a plurality of R component values, a plurality of G component values, and a plurality of B component values of a plurality of RGB color codes of the plurality of converted color labels corresponding to the part of the plurality of the grid space coordinates in the region of interest to get a R component average value, a G component average value, and a B component average value respectively as an average converted color code, and one of the plurality of RGB color codes of the plurality of converted color labels closest to the average converted color code is determined by comparison to access a range representative value of an average parameter value range of the plurality of the value ranges as an average environmental parameter reconstruction data.

In one preferred embodiment of the present invention, the environmental data collecting device can be a network data server, and the network data server may receive the coordinate-bound type environment data set accessed by a plurality of environment monitoring device disposed in the monitored space through an Internet of Things (IoT). The coordinate-bound type environment data set collected by the environmental data collecting device may comprise at least one selected from a group composed of a coordinate-bound type temperature data set, a coordinate-bound type humidity data set, a coordinate-bound type wind speed data set, a coordinate-bound type wind pressure data set, and a coordinate-bound type pollutant concentration data set.

In one preferred embodiment of the present invention, the computing device is an industrial computer, a desktop computer, a laptop computer, a server, or a smart phone. Preferably, the computing device may further comprise a storing module, and the storing module can be used for storing the color space graphical data.

In conclusion, the interactive system with two-way transforming function between environmental parameter data and color space image provided in the present invention not only can transform the coordinate-bound type environment data set into a color space graphical data according to the color label transforming regulation, because the color space graphical data comprises converted color labels (which may be defined by color codes) corresponding to each grid space coordinate, when working together with the regeneration transforming calculation technology for the region of interest data reconstruction module, the effect to retrieve the environmental parameter data in the region of interest rapidly can be achieved through a proper operation to meet the research and analysis need of experts.

With the mutual cooperation of aforementioned technologies, a new type of data structure capable of two-way transforming between parameter data and image data rapidly, i.e. the type of data structure of the aforementioned color space graphic data, is created. The color space graphical data not only can be used to show the color space image rapidly for the experts to execute a more intuitive analysis, but also can restore and reconstruct the data corresponding to the grid space coordinates of all (when all regions are selected as region of interest) or some regions of the color space image through regeneration transforming calculation to generate the environmental parameter reconstruction data with extreme errors (in compared with the environmental parameter original data). Therefore, both visual observation and data analysis can be satisfied without the need of simultaneously storing the environmental parameter original data and the image data, and thus with no doubt, the technology provided in the present invention can also achieve the effect of reducing data storage space.

Further features of the present invention would be described in the following embodiments and figure.

### BRIEF DESCRIPTION OF THE DRAWINGS

FIG. 1 is a function block diagram showing an interactive system with two-way transforming function between environmental parameter data and color space image provided in accordance with a preferred embodiment of the present invention and the surrounding related devices.

FIG. 2 is a schematic view showing the relationship between the monitored space and the obstacle region, as well as the space coordinate system and the grid space coordinate.

FIG. 3 is a schematic view showing the coordinate-bound type environment data set corresponding to the grid space coordinate and environmental parameter original data.

FIG. 4 is a schematic view showing the color space transforming module transforming the coordinate-bound type environment data set to the color space image of the color space graphic data according to the color label transforming regulation.

FIG. 5 is a schematic view showing the region of interest in the color space image is selected and inputted.

FIG. 6 is a schematic view showing the corresponding part of the color space image and the corresponding converted color label retrieved according to the selected and inputted region of interest.

FIG. 7 is schematic view showing wind speed reconstruction data corresponding to part of the grid space coordinate in the region of interest.

FIG. 8 is a schematic view showing the RGB color codes corresponding to part of the grid space coordinate in the region of interest inquired according to the converted color label corresponding to the grid space coordinate.

FIG. 9 is schematic view showing layered data when the color space graphical data is quasi-3D color space graphical data.

### DETAILED DESCRIPTION OF THE EMBODIMENTS

Specific implementations of this disclosure are further described in detail below with reference to the accompanying drawings. According to the following descriptions and claims, the advantages and features of this disclosure are clearer. It should be noted that the drawings are drawn by using an extremely simplified form and imprecise proportion, which are only used for conveniently and clearly assisting in explaining the objective of the embodiments of this disclosure.

The interactive system with two-way transforming function between environmental parameter data and color space image provided in the present invention can be broadly applied to various existed environmental parameter data processes, which do not repeat herein but only one preferred embodiment is described in the following detailed description for explaining the purpose and effect of the embodiments of the present invention.

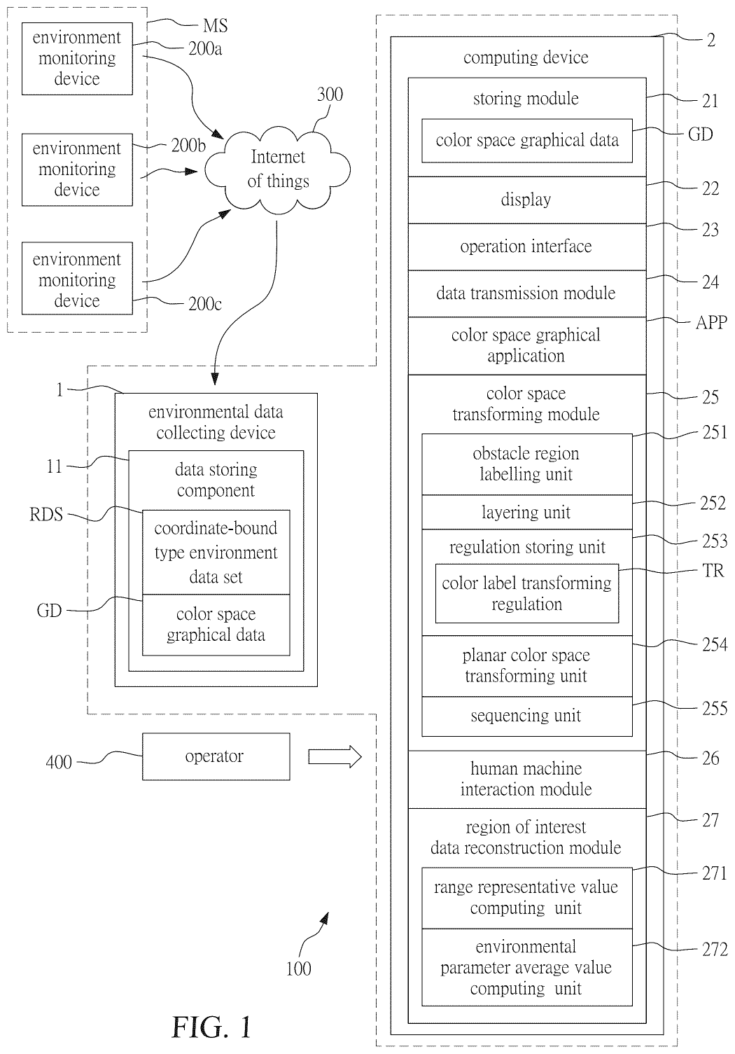

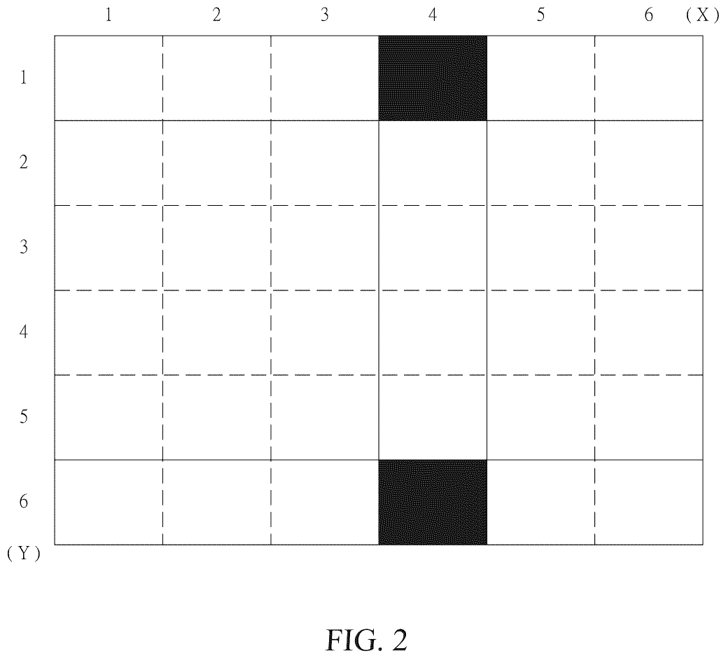

FIG. 1 is a function block diagram showing an interactive system with two-way transforming function between environmental parameter data and color space image provided in accordance with a preferred embodiment of the present invention and the surrounding related devices. As shown in FIG. 1, an interactive system with two-way transforming function between environmental parameter data and color space image 100 (hereinafter referred to as “interactive system”) comprises an environmental data collecting device 1 and a computing device 2. A plurality of environment monitoring devices (only three environment monitoring devices 200a, 200b, and 200c are shown in the present embodiment) are disposed in a monitored space MS for monitoring a plurality of environmental parameter original data corresponding to a plurality of grid space coordinates in a space coordinate system of the monitored space MS (such as the XY space coordinate system labelled in FIG. 2).

The environment monitoring devices 200a, 200b, and 200c can be disposed on a moving carrier or attached to any monitoring position in the monitored space MS, and can access a plurality of environmental parameter original data corresponding to a plurality of grid space coordinates in a space coordinate system by using moving detection or fixed position detection together with simulation and derivation of algorithm model. The monitored space MS can be an indoor space or an outdoor space.

The environmental data collecting device 1 can be an environmental data server and comprises a data storing component 11. The data storing component 11 can be a hard disk of the environmental data server. The environmental data collecting device 1 (such as the environmental data server) may communicated with the environment monitoring device 200a, 200b, and 200c through an Internet of Things 300 for collecting grid space coordinates in the space coordinate system and corresponding environmental parameter data respectively, and organizing the grid space coordinates in the space coordinate system and corresponding environmental parameter data as a coordinate-bound type environment data set RDS stored in data storing component 11.

The aforementioned coordinate-bound type environment data set RDS may comprises at least one selected from a group composed of a coordinate-bound type temperature data set, a coordinate-bound type humidity data set, a coordinate-bound type wind speed data set, a coordinate-bound type wind pressure data set, and a coordinate-bound type pollutant concentration data set. In some specific applications, the coordinate-bound type environment data set RDS can be an algorithm processed coordinate-bound type indoor environment comfort level data set or a coordinate-bound type outdoor environment comfort level data set.

The computing device 2 can be an industrial computer, a desktop computer, a laptop computer, a server, or a smart phone, which is wired or wireless communicated with the environmental data collecting device 1 to receive the coordinate-bound type environment data set RDS. The computing device 2 comprises a storing module 21, a display 22, an operation interface 23, and a data transmission module 24, is installed with a color space graphical application APP, and after executing the color space graphical application APP, a color space transforming module 25, a human machine interaction module 26, and a region of interest data reconstruction module 27 is generated.

The storing module 21 can be a built-in data storing component or a plug-in data storing component of the computing device 2, such as the hard disk, built-on memory, or an external memory card. The display 22 can be a touch display or a display without touch screen. The operation interface 23 can be a touch control element built in the (touch) display, a built-in keyboard/mouse, or an external keyboard/mouse. The data transmission module 24 can be a wired or wireless transceiver.

The color space transforming module 25 may build up a color label transforming regulation TR for the plurality of the environmental parameter original data, and the color label transforming regulation TR may comprise a plurality of value ranges and a plurality of corresponding converted color labels such that the coordinate-bound type environment data set RDS can be transformed according to the color label transforming regulation TR to a color space graphical data GD and have the color space graphical data GD stored in the storing module 21.

The color space transforming module may use a RGB color code table, a CMYK color code table or a HEX color code table to define the converted color labels. In the present embodiment, the RBG color code table is used to define the converted color labels. The color space graphical data GD may comprise a color space image corresponding to the monitored space MS, and the color space image is composed of a plurality of colored blocks shown by the converted color labels corresponding to the grid space coordinates.

The color space transforming module 25 may comprise an obstacle region labelling unit 251, and the obstacle region labelling unit 251 can be used for labelling at least one area of a monitored region not belonging to the monitored space MS as at least one obstacle region, and using an obstacle specified color label other than the converted color labels to label the obstacle region.

In addition, the color space graphical data GD can be a planar type color space graphical data or a quasi-3D color space graphical data. When the color space graphical data GD is a quasi-3D color space graphical data, the color space transforming module 25 may comprises a layering unit 252, a regulation storing unit 253, a planar color space transforming unit 254, and a sequencing unit 255.

The layering unit 252 is for dividing the monitored space MS into a plurality of planar spaces arranged according to a stacking order. The planar space comprises part of the plurality of the grid space coordinates. The regulation storing unit 253 corresponds to the environmental parameter original data for building up the data storing format of the color label transforming regulation TR in the storing module 21 so as to store the color label transforming regulation TR.

The planar color space transforming unit 254 is for transforming the environmental parameter original data corresponding to the grid space coordinates of each of the planar spaces Z1 to Z3 into a planar color space graphical data, so as to generate a plurality of the afore-mentioned planar color space graphical data. The sequencing unit 255 is for arranging the plurality of the planar color space graphical data according to the stacking order so as to compose the quasi-3D color space graphical data.

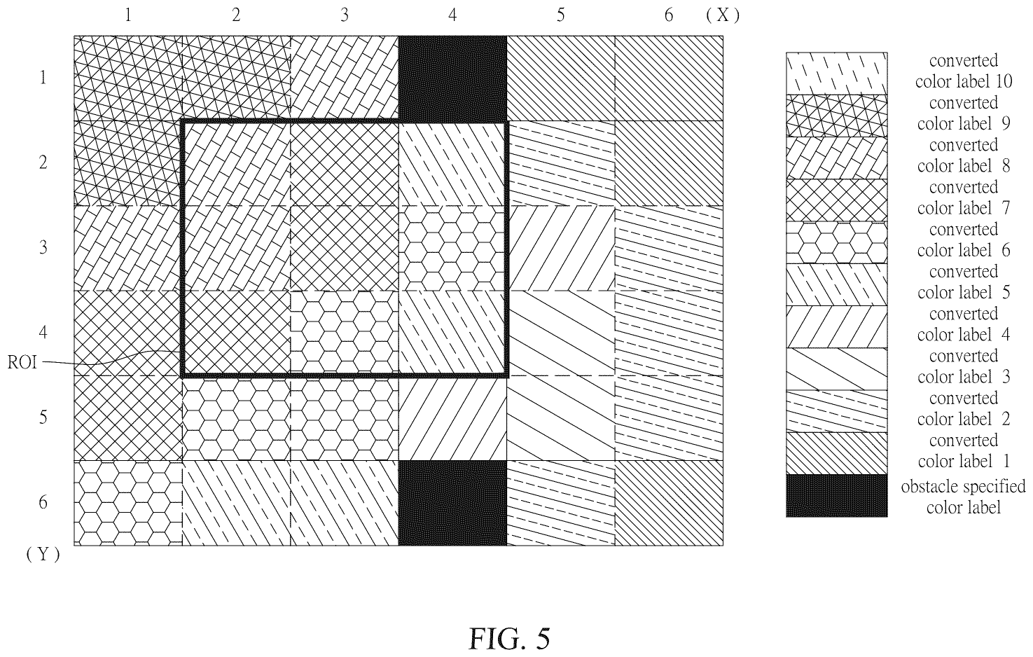

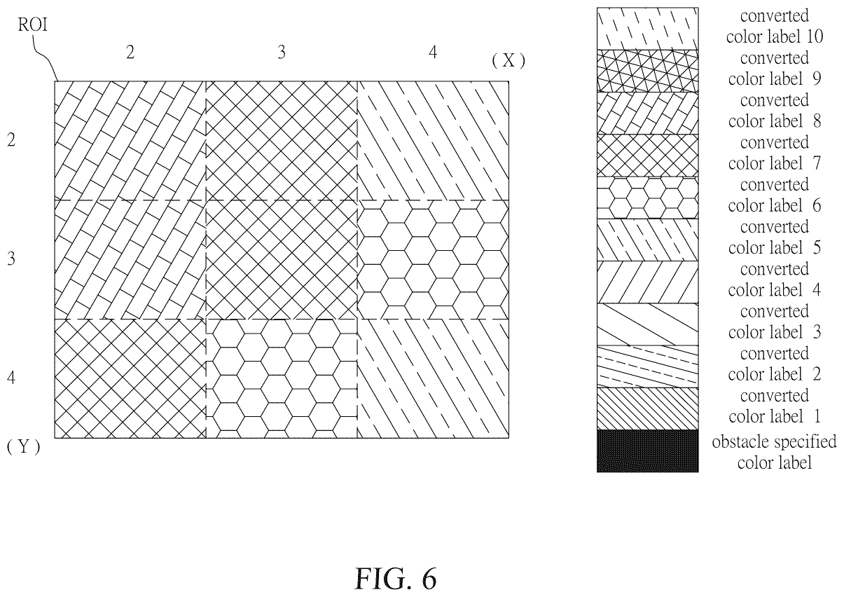

The human machine interaction module 26 can be an operation image or an operation webpage shown on the display 22. An operator 400 may observe the color space graphical data GD shown on the operation image or the operation webpage, and select and input a region of interest ROI (labelled in FIG. 5 and FIG. 6) in the color space image through the operation interface 23. In addition, the human machine interaction module 26 may allow the operator 400 to build up new color label transforming regulation TR or amend the color label transforming regulation TR built-up previously.

The region of interest data reconstruction module 27 may retrieve the converted color labels corresponding to part of the plurality of the grid space coordinates in the region of interest ROI according to the selected and inputted region of interest ROI, and execute a regeneration transforming calculation according to the color label transforming regulation TR to generate a plurality of environmental parameter reconstruction data corresponding to the part of the plurality of the grid space coordinates in the region of interest ROI, and have them shown on the human machine interaction module 26, i.e. the afore-mentioned operation image or the operation webpage shown on the display 22.

Preferably, the region of interest data reconstruction module 27 may comprise a range representative value computing unit 271 and an environmental parameter average value computing unit 272. The range representative value computing unit 271 may execute the regeneration transforming calculation to calculate a range representative value of each of the plurality of value ranges, so as to build up a value reconstruction table by using the range representative values corresponding to the plurality of converted color labels. Preferably, the range representative value can be accessed by calculating a middle value of each value range, or by calculating an average value of the environmental parameter original data of each value range.

The environmental parameter average value computing unit 272 may applies average calculation to a plurality of R component values, a plurality of G component values, and a plurality of B component values of a plurality of RGB color codes of the converted color labels corresponding to the grid space coordinates in the region of interest ROI to get a R component average value, a G component average value, and a B component average value respectively as an average converted color code, and one of the plurality of RGB color codes of the plurality of converted color labels closest to the average converted color code (the closest one may be exactly the same) is determined by comparison to access a range representative value of an average parameter value range of the plurality of the value ranges as an average environmental parameter reconstruction data.

The data transmission module 24 may upload the color space graphic data GD to the environmental data collecting device 1 to replace coordinate-bound type environment data set RDS and be stored in the data storing component 11 (such as the hard disk) of the environmental data collecting device 1 (such as the environmental data server). That is, the color space graphical data GD is used to overwrite the coordinate-bound type environment data set RDS.

The detail steps of data processing would be described below together with the drawings. Please refer to FIG. 2, which is a schematic view showing the relationship between the monitored space and the obstacle region, as well as the space coordinate system and the grid space coordinate. As show in FIG. 2, in the present embodiment, the monitored region is an indoor region and is defined by a space coordinate system (XY coordinate system). The monitored region is composed of 6×6 space grids in the XY coordinate system, and the space grid number along the X direction and the Y direction compose the grid space coordinate. Wherein, those with the grid space coordinate of (4,1) and (4.6) are the obstacle regions (i.e. the region occupied by the obstacles such as an indoor pillar, a patio surrounded by walls, a building external wall, or a mountain wall).

In practice, size of the grid space of each grid space coordinate is decided by the factors such as monitoring ability of the environment monitoring device, monitored data density required for executing analysis, data storage capacity, simulation and derivation computing capability of algorithm model, etc. The distance of each grid space along the X direction and that along the Y direction can be the same or not, depends on the overall consideration of the aforementioned factors.

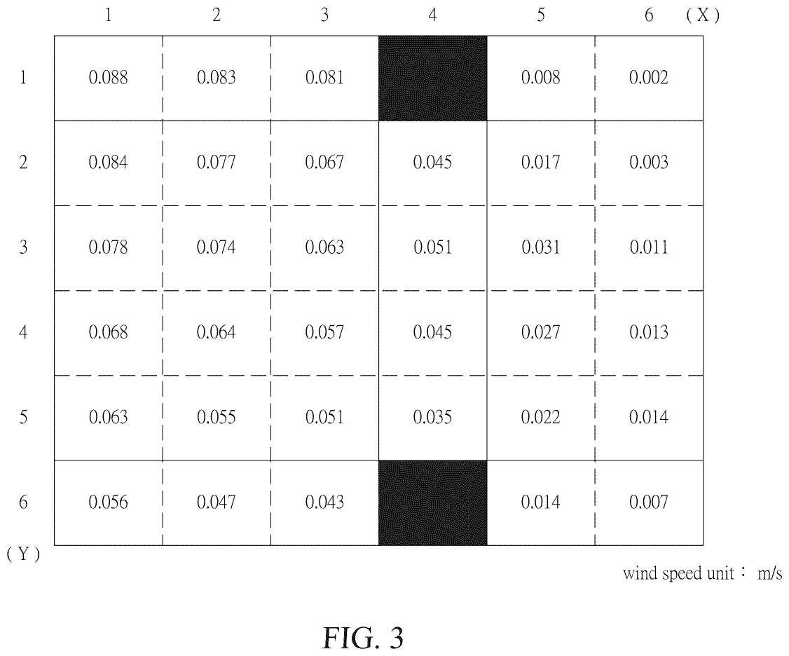

Please keep referring to FIG. 3, which is a schematic view showing the coordinate-bound type environment data set corresponding to the grid space coordinate and environmental parameter original data. As shown in FIG. 3, in the present embodiment, the environmental parameter original data is wind speed original data. Other than the obstacle regions with the grid space coordinates of (4,1) and (4,6), the coordinate-bound type environment data set RDS (labelled in FIG. 1) comprises wind speed original data corresponding to each of the grid space coordinates in the space coordinate system (i.e. the XY coordinate system).

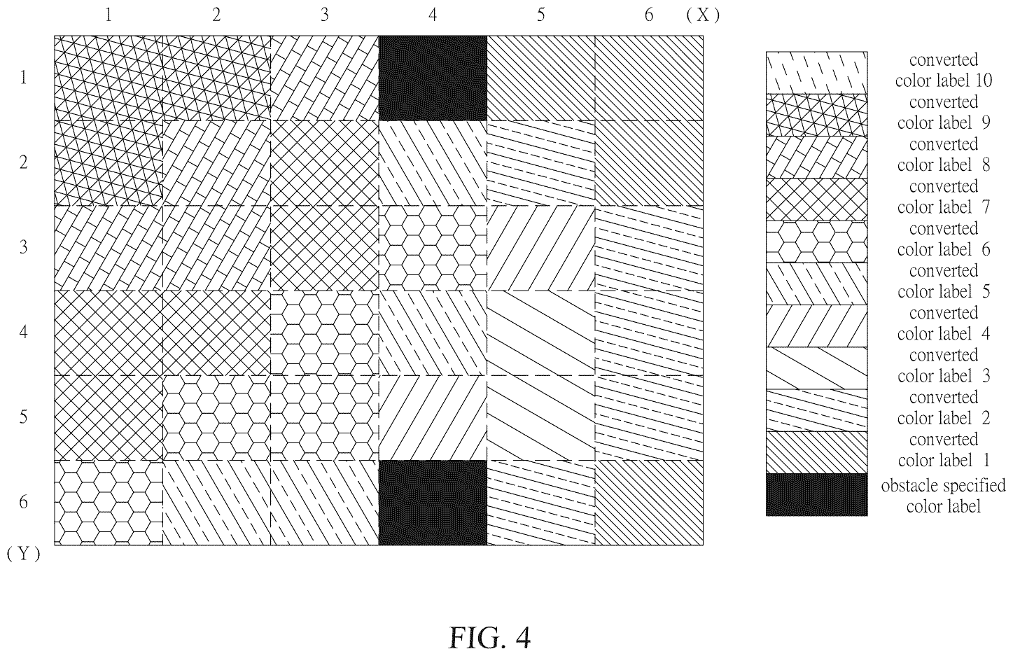

Please keep referring to Table 1 and FIG. 4, wherein Table 1 is a correspondence table of color code, converted color label, value range, and range representative value defined by color label transforming regulation, and FIG. 4 is a schematic view showing the color space transforming module transforming the coordinate-bound type environment data set to the color space image of the color space graphic data according to the color label transforming regulation. Because in the present embodiment, the environmental parameter original data is the wind speed original data, the value range would be the wind speed range, the range representative value would be the wind speed range representative value. In the present embodiment, the range representative value computing unit 271 (labelled in FIG. 1) calculates a middle value of each wind speed range and rounded as the corresponding wind speed range representative value.

RGB color code is a color code system composed of three value sets, i.e. the R component value, the G component value, and the B component value. The range of each component value is 0 to 255, and thus each component value can be divided into 256 levels. For better distinguishing the obstacle region, the obstacle region labelling unit 251 (labelled in FIG. 1) may use the black color label as the obstacle specified color label to label the obstacle region, i. e. the grid space with the grid space coordinates of (4,1) and (4, 6). The R component value, the G component value, and the B component value of the black color label are all 0, and thus the RGB code of the black color label is (0,0,0).

TABLE 1
Correspondence table of color code, converted color
label, value range, and range representative value
defined by color label transforming regulation.

| | | Wind speed | Wind speed range |
|---|---|---|---|
| RGB color | converted color | range | representative value |
| code | label | (m/s) | (m/s) |
| (50, 50, 50) | converted color | 0.000~0.009 | 0.005 |
| | label 1 | | |
| (100, 50, 50) | converted color | 0.010~0.019 | 0.015 |
| | label 2 | | |
| (150, 50, 50) | converted color | 0.020~0.029 | 0.025 |
| | label 3 | | |
| (200, 50, 50) | converted color | 0.030~0.039 | 0.035 |
| | label 4 | | |
| (250, 50, 50) | converted color | 0.040~0.049 | 0.045 |
| | label 5 | | |
| (50, 100, 50) | converted color | 0.050~0.059 | 0.055 |
| | label 6 | | |
| (50, 150, 50) | converted color | 0.060~0.069 | 0.065 |
| | label 7 | | |
| (50, 200, 50) | converted color | 0.070~0.079 | 0.075 |
| | label 8 | | |
| (50, 250, 50) | converted color | 0.080~0.089 | 0.085 |
| | label 9 | | |
| (50, 50, 100) | converted color | 0.090~0.099 | 0.095 |
| | label 10 | | |

A person with ordinary skilled in the art would understand that the relationship of color code, converted color label, value range, and range representative value defined by the aforementioned color label transforming regulation TR can be defined not only by using a correspondence table, but also by using an adequate transforming function, and thus the scope of the present invention should not be restricted to the usage of a correspondence table.

Theoretically, when using RGB color code to define the converted color label, a total number of 256×256×256 different color codes and corresponding converted color labels can be defined, that is, 16777216 different converted color labels. By excluding the RGB color code (0,0,0) which is used specifically to represent obstacle regions, 16777215 different RGB color codes are left which can be used to define 16777215 different corresponding converted color labels and wind speed range.

In practice, in order to prevent the color of the converted color label and the color of the obstacle region too similar to cause the problem of lacking recognition, the color codes with the R component value, the G component value, and the B component value smaller than a specific value can be excluded. For example, the color codes with the R component value, the G component value, and the B component value smaller than 50 can be excluded, and only those with the R component value, the G component value, and the B component value ranged from 50-255 are used for building up the converted color labels. Even though, a total number of 206×206×206 different RGB color codes are left, that is, 8741816 different RGB color codes can be used for defining 8741816 different corresponding converted color labels and wind speed range. Thus, the significant digits for analyzing wind speed range representative value can reach 6 to 7 digits.

Of course, if the significant digits required for doing data analysis is only 3 or 4 digits, it can be simplified to use only 10000 or 100000 different RGB color codes for defining 10000 or 100000 different corresponding converted color labels and wind speed range. In the present embodiment, for illustration purpose, only 10 RGB color codes thereof are used for defining 10 different corresponding converted color labels, wind speed ranges, and wind speed range representative values. In practice, the correspondence table shown in Table 1 usually uses more than 100 RGB color codes.

With the correspondence of color code, converted color label, value range and range representative value defined by the color label transforming regulation TR, the wind speed original data of each grid space coordinate of the coordinate-bound type environment data set RDS can be transformed into the color space graphical data GD, the color space graphical data GD may comprise a color space image corresponding to the monitored space MS (labeled in FIG. 1), and the color space image is composed of 34 colored blocks (excluding 2 blocks corresponding to obstacle region) shown by the converted color labels corresponding to the grid space coordinate.

Please keep referring to FIG. 1, FIG. 5 and FIG. 6, wherein FIG. 5 is a schematic view showing the region of interest in the color space image is selected and inputted, and FIG. 6 is a schematic view showing the corresponding part of the color space image and the corresponding converted color label retrieved according to the selected and inputted region of interest. As shown in FIG. 1 and FIG. 5, after watching the color space image shown in the operation image or the operation webpage displayed on the display 22, the operator 400 may operates the aforementioned operation interface 23 to select and input the region of interest ROI. FIG. 5 shows the region of interest ROI selected by the operator 400 including the region composed of 9 grid spaces with the grid space coordinates of (2,2) to (4,4).

Because the color space image has an user friendly expression facilitating rapid recognition, the operator 400 may rapidly and intuitively select and input the regions which require particular attention (such as the region where data changes drastically, where an object sensitive to environmental change needs to be installed, or where a specific environmental condition needs to be maintained) as the region of interest which is used as a basis for following analysis. Then, according to the selected and inputted region of interest ROI, the region of interest data reconstruction module 27 may retrieve the corresponding part of the color space image (shown in FIG. 6) and the corresponding converted color labels.

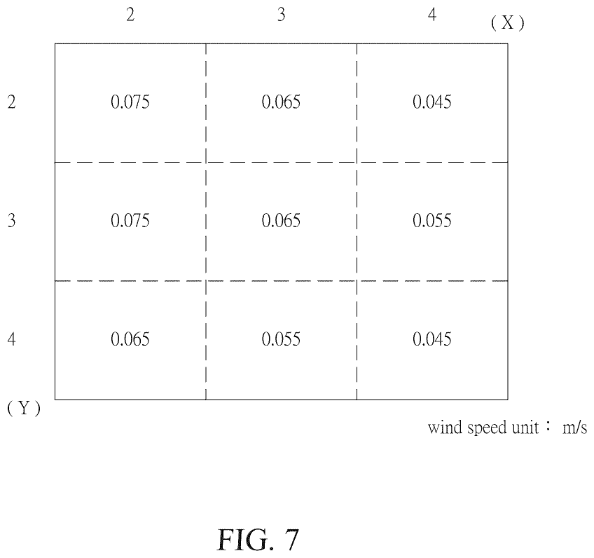

Please keep referring to FIG. 6, FIG. 7 and Table 1, wherein FIG. 7 is schematic view showing wind speed reconstruction data corresponding to part of the grid space coordinate in the region of interest. The aforementioned following analysis comprises data reconstruction. That is, the region of interest data reconstruction module 27 (labelled in FIG. 1) may depend on the retrieved converted color labels corresponding to part of the plurality of the grid space coordinates in the region of interest ROI, and execute a regeneration transforming calculation according to the color label transforming regulation TR (labelled in FIG. 1) to generate the environmental parameter reconstruction data (i.e. wind speed reconstruction data) corresponding to part of the grid space coordinates in the region of interest ROI shown on the human machine interaction module 26 (labelled in FIG. 1).

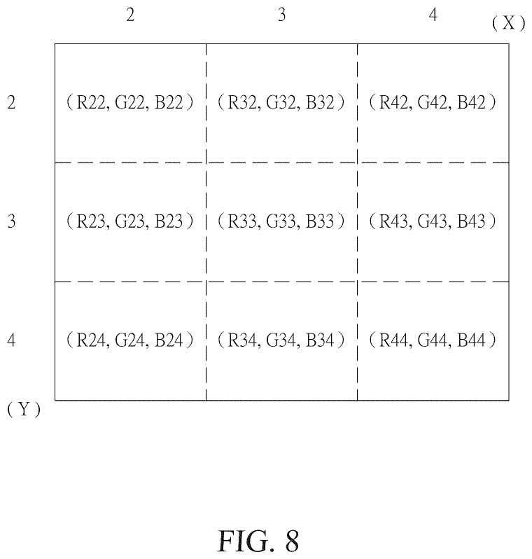

Please keep referring to FIG. 7, FIG. 8 and Table 1, wherein FIG. 8 is a schematic view showing the RGB color codes corresponding to part of the grid space coordinate in the region of interest inquired according to the converted color label corresponding to the grid space coordinate. The region of interest data reconstruction module 27 (labelled in FIG. 1) may figure out that the 9 RGB color codes corresponding to the grid space coordinates (2,2) to (4,4) are (R22,G22,B22) to (R44,G44,B44) according to Table 1. The following analysis for the region of interest ROI comprises calculating reconstruction average wind speed of the region of interest. The environmental parameter average value computing unit 272 may apply average calculation to 9 R component values (R22˜R44), 9 G component values (G22˜G44), and 9 B component values (B22˜B44) of the converted color labels corresponding to the grid space coordinates (2,2) to (4,4) in the region of interest ROI to get a R component average value, a G component average value, and a B component average value respectively as an average converted color code.

Then, after determining the one of the RGB color codes of the converted color labels closest to the average converted color code (the closest one may be exactly the same) by comparison, a range representative value of an average parameter value range of the value ranges is accessed accordingly as an average environmental parameter reconstruction data (i.e. the reconstruction average wind speed). The so called “closest” can be defined by computing quadratic mean of the differences of each of the components of RGB color codes of the average converted color code and each of the converted color label or other approximation method.

Because the RGB color codes can be used to define the wind speed range with significant digits of 3 or 4 digits, or even the wind speed range with significant digits of 6 or 7 digits, thus, error of both wind speed reconstruction data and reconstruction average wind speed can be controlled at a very low level, or even within monitoring margin of error of wind speed original data.

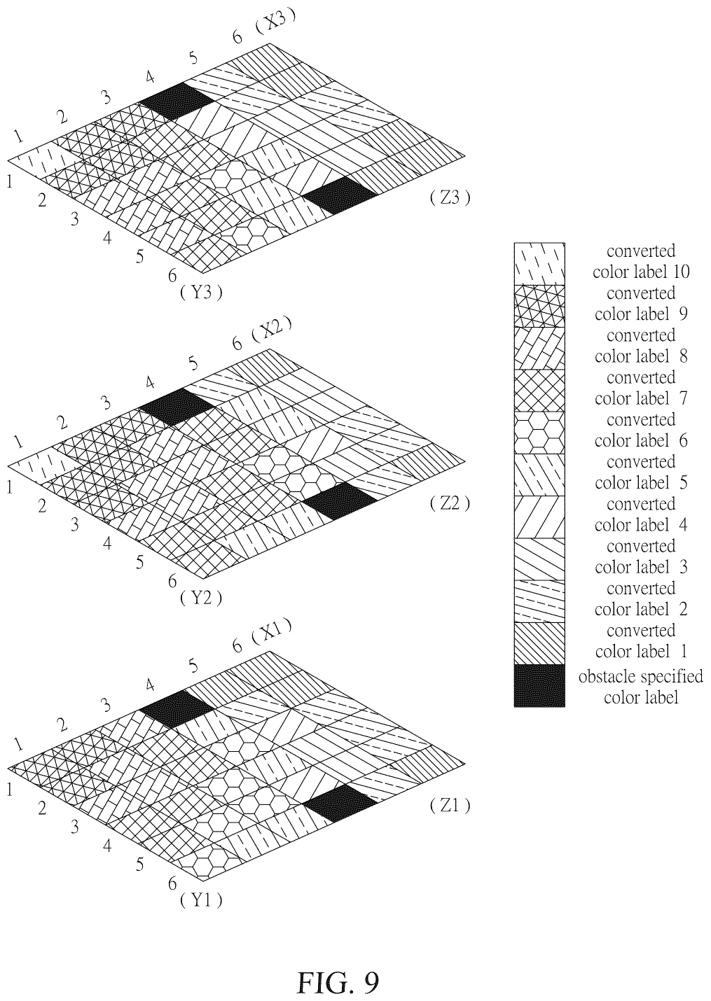

Please keep referring to FIG. 1 and FIG. 9, wherein FIG. 9 is a schematic view showing layered data when the color space graphical data is quasi-3D color space graphical data. As shown in FIG. 1 and FIG. 9, when the color space graphical data is quasi-3D color space graphical data GD, the layering unit 252 may divide the monitored space MS into three planar spaces Z1˜Z3 arranged according to a stacking order. The planar spaces Z1˜Z3 comprises 34 grid space coordinates defined by X1Y1 coordinate system, 34 grid space coordinates defined by X2Y2 coordinate system, and 34 grid space coordinates defined by X3Y3 coordinate system respectively. The regulation storing unit 253 corresponds to wind speed original data for storing the built-up color label transforming regulation TR.

The planar color space transforming unit 254 may transform the environmental parameter original data corresponding to the grid space coordinates of each of the planar spaces Z1 to Z3 into a planar color space graphical data, so as to generate 3 planar color space graphical data. The sequencing unit 255 is for arranging the planar color space graphical data according to the stacking order (i.e. the stacking order for the planar spaces Z1˜Z3) so as to compose the quasi-3D color space graphical data GD as shown in FIG. 9. The so called quasi-3D color space graphical data GD indicates a similar but not real 3D color space graphical data GD, i.e. the color space graphical data GD with a third (layered) component along the layered stacking direction.

After the quasi-3D color space graphical data GD is generated, when using the human machine interaction module 26 to select and input the region of interest ROI, after selecting anyone of X1Y1 coordinate system to X3Y3 coordinate system, the layer to be stretched can be selected to have the region of interest ROI comprises a cross-layer region. After select and input the region of interest ROI, the wind speed reconstruction data and the reconstruction average wind speed can be calculated in the same way, which is not repeated here.

The converted color label is substantially a color label marked by color. In the drawings of the present invention, different patterns are used to represent different colors. In practice, colors of the colored block of the color space image of the color space graphical data GD are corresponding to colors of the converted color labels.

In conclusion, the interactive system 100 with two-way transforming function between environmental parameter data and color space image provided in the present invention not only can transform the coordinate-bound type environment data RDS set into a color space graphical data GD according to the color label transforming regulation TR, because the color space graphical data GD comprises converted color labels (which may be defined by color codes) corresponding to each grid space coordinate, With the mutual cooperation of aforementioned technologies, a new type of data structure capable of two-way transforming between parameter data and image data rapidly, i.e. the type of data structure of the aforementioned color space graphic data, is created. The color space graphical data not only can be used to show the color space image rapidly for the experts to execute a more intuitive analysis, but also can restore and reconstruct the data corresponding to the grid space coordinates of all (when all regions are selected as region of interest) or some regions of the color space image through regeneration transforming calculation to generate the environmental parameter reconstruction data with extreme errors (in compared with the environmental parameter original data). Therefore, both visual observation and data analysis can be satisfied without the need of simultaneously storing the environmental parameter original data and the image data, and thus with no doubt, the technology provided in the present invention can also achieve the effect of reducing data storage space. with the regeneration transforming calculation technology for the region of interest data reconstruction module 27, the effect to retrieve the environmental parameter data in the region of interest ROI rapidly can be achieved through a proper operation to meet the research and analysis need of experts (i.e. the operator 400).

With the mutual cooperation of aforementioned technologies, a new type of data structure capable of two-way transforming between parameter data and image data rapidly, i.e. the type of data structure of the aforementioned color space graphic data GD, is created. The color space graphical data not only can be used to show the color space image rapidly for the experts to execute a more intuitive analysis, but also can restore and reconstruct the data corresponding to the grid space coordinates of all (when all regions are selected as region of interest) or some regions of the color space image through regeneration transforming calculation to generate the environmental parameter reconstruction data with extreme errors (in compared with the environmental parameter original data). Therefore, both visual observation and data analysis can be satisfied without the need of simultaneously storing the environmental parameter original data and the image data, and thus with no doubt, the technology provided in the present invention can also achieve the effect of reducing data storage space.

The foregoing descriptions are merely preferred embodiments of this disclosure, and do not constitute any limitation on this disclosure. Any form of variation such as equivalent replacement or modification made to the technical means and technical content disclosed in this disclosure without departing from the scope of the technical means of this disclosure is the content of the technical means of this disclosure and still falls within the protection scope of this disclosure.

What is claimed is:

1. An interactive system with two-way transforming function between environmental parameter data and color space image comprising:
an environmental data collecting device, collecting a coordinate-bound type environment data set of a monitored space, and the coordinate-bound type environment data set comprising a plurality of environmental parameter original data corresponding to a plurality of grid space coordinates in a space coordinate system of the monitored space; and
a computing device, communicating with the environmental data collecting device for receiving the coordinate-bound type environment data set, installed with a color space graphical application, and after executing the color space graphical application, the computer device generating:
a color space transforming module, building up a color label transforming regulation for the plurality of environmental parameter original data, wherein the color label transforming regulation comprises a plurality of value ranges and a plurality of corresponding converted color labels so as to transform the coordinate-bound type environment data set to a color space graphical data by using the color label transforming regulation, wherein the color space graphical data comprises a color space image corresponding to the monitored space, and the color space image is composed of a plurality of colored block shown by the plurality of the converted color labels corresponding to the plurality of the grid space coordinates;
a human machine interaction module, showing the color space graphical data for an operator to watch and select a region of interest in the color space image of the color space graphical data; and
a region of interest data reconstruction module, retrieving the converted color labels corresponding to part of the plurality of the grid space coordinates in the region of interest, and executing a regeneration transforming calculation according to the color label transforming regulation to generate a plurality of environmental parameter reconstruction data corresponding to the part of the plurality of the grid space coordinates in the region of interest shown on the human machine interaction module.

2. The interactive system with two-way transforming function between environmental parameter data and color space image of claim 1, wherein the color space transforming module further comprises:
a layering unit, dividing the monitored space into a plurality of planar spaces arranged according to a stacking order, wherein each of the plurality of the planar spaces comprises part of the plurality of the grid space coordinates;
a regulation storing unit, corresponding to the environmental parameter original data for storing the built-up color label transforming regulation;
a planar color space transforming unit, for transforming the environmental parameter original data corresponding to the grid space coordinates of each of the more than two of the planar spaces into a planar color space graphical data, so as to generate a plurality of the planar color space graphical data; and
a sequencing unit, for arranging the plurality of the planar color space graphical data according to the stacking order so as to compose the color space graphical data.

3. The interactive system with two-way transforming function between environmental parameter data and color space image of claim 1, wherein the color space transforming module further comprises an obstacle region labelling unit, wherein the obstacle region labelling unit is for labelling a portion of a monitored region not belonging to the monitored space as at least one obstacle region, and using an obstacle specified color label other than the plurality of the converted color labels to label the at least one obstacle region.

4. The interactive system with two-way transforming function between environmental parameter data and color space image of claim 1, further comprising a data transmission module, wherein the data transmission module is for uploading the color space graphic data to the environmental data collecting device to replace coordinate-bound type environment data set and being stored in the environmental data collecting device.

5. The interactive system with two-way transforming function between environmental parameter data and color space image of claim 1, wherein the region of interest data reconstruction module comprises a range representative value computing unit, and the range representative value computing unit executes the regeneration transforming calculation to calculate a range representative value of each of the plurality of value range, so as to build up a value reconstruction table by using the range representative values corresponding to the plurality of converted color labels.

6. The interactive system with two-way transforming function between environmental parameter data and color space image of claim 5, wherein the range representative value computing unit executes the regeneration transforming calculation to calculate a middle value of each of the plurality of the value ranges as the range representative value thereof.

7. The interactive system with two-way transforming function between environmental parameter data and color space image of claim 5, executes the regeneration transforming calculation to calculate an average value of the plurality of the environmental parameter original data of each of the plurality of the value ranges as the range representative value thereof.

8. The interactive system with two-way transforming function between environmental parameter data and color space image of claim 5, wherein the color space transforming module uses a RGB color code table, a CMYK color code table or a HEX color code table to define the plurality of the converted color labels.

9. The interactive system with two-way transforming function between environmental parameter data and color space image of claim 8, wherein the region of interest data reconstruction module further comprises an environmental parameter average value computing unit, and when using the RGB color code table to define the plurality of the converted color labels, the environmental parameter average value computing unit applies average calculation to a plurality of R component values, a plurality of G component values, and a plurality of B component values of a plurality of RGB color codes of the plurality of converted color labels corresponding to the part of the plurality of the grid space coordinates in the region of interest to get a R component average value, a G component average value, and a B component average value respectively as an average converted color code, and one of the plurality of RGB color codes of the plurality of converted color labels closest to the average converted color code is determined by comparison to access a range representative value of an average parameter value range of the plurality of the value ranges as an average environmental parameter reconstruction data.

10. The interactive system with two-way transforming function between environmental parameter data and color space image of claim 1, wherein the environmental data collecting device is a environmental data server.

11. The interactive system with two-way transforming function between environmental parameter data and color space image of claim 10, wherein the environmental data server receives the coordinate-bound type environment data set accessed by a plurality of environment monitoring device disposed in the monitored space through an Internet of Things (IoT).

12. The interactive system with two-way transforming function between environmental parameter data and color space image of claim 1, wherein the computing device further comprises a storing module, and the storing module is for storing the color space graphical data.

13. The interactive system with two-way transforming function between environmental parameter data and color space image of claim 1, wherein the coordinate-bound type environment data set collected by the environmental data collecting device comprises at least one selected from a group composed of a coordinate-bound type temperature data set, a coordinate-bound type humidity data set, a coordinate-bound type wind speed data set, a coordinate-bound type wind pressure data set, and a coordinate-bound type pollutant concentration data set.

14. The interactive system with two-way transforming function between environmental parameter data and color space image of claim 1, wherein the computing device is an industrial computer, a desktop computer, a laptop computer, a server, or a smart phone.
